(19) United States
(12) Patent Application Publication
(10) Pub. No.: US 2025/0390365 A1
(43) Pub. Date: Dec. 25, 2025

(54) System and Methods For Integration of APIs in a No Code Environment

(71) Applicant: Nu Computing Abstraction Layer LLC, Bloomfield, NJ (US)

(72) Inventor: Yagmur Sahin, Verona, NJ (US)

(21) Appl. No.: 19/240,954

(22) Filed: Jun. 17, 2025

Related U.S. Application Data
(60) Provisional application No. 63/662,081, filed on Jun. 20, 2024.

(51) Int. Cl. G06F 9/54

(52) U.S. Cl. CPC G06F 9/547; G06F 2209/547

(57) ABSTRACT

There is provided a system and method for a backend package to facilitate global connectivity and seamless integration through standardized API interactions. A managed user authentication across all provider interactions allows for construction of custom user interfaces using parject JSONs, integrated with a no-code platform, specifically within its UI flow engine. This integration enhances the relationship between UI elements and the backend side using mapping techniques, allowing for designing and creating interactive and dynamic web applications. Specialized microservices are included in the system and methods.

### CROSS REFERENCE TO RELATED APPLICATIONS

This application claims benefit of and priority to U.S. Provisional Patent Application Ser. No. 63/662,081, filed on Jun. 20, 2024 and incorporated herein by reference in its entirety.

### FIELD OF THE INVENTION

The present invention relates to connectivity to a platform, and more particularly to API integration.

### BACKGROUND

Companies have traditionally used several older or existing methods to perform similar functions of connectivity and integration, which typically involved more complexity and less integration flexibility. These included, but were not limited to:

Manual API Integration: Companies often had to manually integrate each provider's API. This process required significant development resources to understand, implement, and maintain each API separately. It was not only time-consuming but also prone to errors, especially when dealing with multiple providers.

Multiple Middleware Solutions: To handle different APIs and services, companies frequently relied on multiple middleware solutions. Each middleware would handle different sets of APIs, leading to increased complexity in managing these solutions and ensuring they worked seamlessly together.

Custom Authentication Systems: Prior to standardized solutions, businesses needed to develop and maintain their own authentication systems for each provider. This approach required additional security measures and complicated the integration process as each system needed to be compatible with various API security protocols.

Proprietary Connector Services: Some companies created their own backend systems, but tailored specifically to their needs. While this allowed for custom solutions, it limited the flexibility to scale or adapt to new providers without significant redevelopment.

Third-party Integration Platforms: Although third-party platforms have been used, they often come with user interfaces and predefined workflows, which might not offer the level of customization and control needed by some businesses. Additionally, these platforms can sometimes lack the depth required for more complex or highly customized integrations.

Custom Code Development: Businesses sometimes developed custom code to manage API interactions and data flows, which required ongoing maintenance and updates as APIs and technologies evolved.

These methods generally resulted in higher costs, longer development times, and less agility in responding to new opportunities or technological changes.

Additionally, the older and existing methods of API integration and management come with several disadvantages that can impact business efficiency, scalability, and adaptability:
High Complexity and Resource Intensiveness: Manual integration of each provider's API requires significant technical expertise and manpower. This method is not only time-consuming but also prone to human error, making it inefficient and costly for companies needing to manage multiple integrations;
Limited Scalability: With multiple middleware solutions or proprietary connector services, scaling up as business needs grow can become cumbersome. Each new integration or adjustment might require additional configuration or even new middleware, complicating the system further and increasing maintenance costs.

Inflexibility: Custom authentication systems and proprietary services generally lack the flexibility needed to quickly adapt to new APIs or changes in existing ones. This rigidity can delay the adoption of new technologies or hinder the company's ability to respond to market changes.

Security Risks: Managing security for custom authentication systems and multiple integrations increases the risk of inconsistencies in security protocols and potential vulnerabilities. This can expose businesses to security breaches and data leaks.

Dependency on External Platforms: Using third-party integration platforms often means relying on the external platform's capabilities and limitations. This can restrict the business's control over their workflows and data, and they may also be affected by changes or disruptions in the service provided by these platforms.

High Maintenance Costs: Custom code development and multiple middleware solutions require ongoing maintenance to address bugs, update APIs, and ensure compatibility with new technologies. This continual need for technical support results in higher long-term costs.

Inefficiency in Handling Large Volumes of Data: Older methods often struggle with efficiently managing large volumes or complex structures of data. This can lead to performance bottlenecks, slower response times, and ultimately a poor user experience.

These disadvantages highlight the need for a more streamlined, flexible, and scalable solution which aims to overcome these challenges by providing a comprehensive backend package that simplifies, reduces complexity and overhead and enhances API integration and management.

### SUMMARY

The present invention, described as Parject as a Service (PaaS), relates to a comprehensive backend package designed to facilitate global connectivity and seamless integration for vendors and companies through standardized API interactions. This system of the present invention does not offer a user interface, but rather, provides a robust backend solution. The present invention manages user authentication across all provider interactions and allows companies, vendors, and third parties to construct custom user interfaces using parject JSONs. The present invention involves integrating this PaaS package into a no-code platform, such as provided by Nu Computing Abstraction Layer LLC, specifically within its user interface (UI) flow engine. This integration aims to enhance the relationship between UI elements and the backend side using mapping techniques, making it easier for users to design and create interactive and dynamic web applications. The general technological area of this invention encompasses backend as a Service (BaaS), platform as a Service (PaaS), and workflow automation, focusing on improving and streamlining backend integrations and automation capabilities for businesses, particularly those utilizing workflow builders and automation platforms.

The purpose of the Parject as a Service (PaaS) present invention is to provide a comprehensive backend solution that enables seamless connectivity and interaction with a wide range of service providers globally through a single, standardized request. This invention aims to simplify the integration process for companies by managing user authentication and handling all API responses, including errors, through its specialized microservices, such as Dispatcher and PaaS Authentication.

The objectives with the present invention are:

Global Connectivity: To enable businesses worldwide to easily connect with any provider without the need for complex individual integrations, thereby saving time and reducing the complexity involved in handling multiple APIs.

Unified Integration: To offer a standardized method of integration through parject JSONs, which allows companies to create and customize user interfaces efficiently. This unified approach helps maintain consistency across various integrations and interactions with service providers.

Enhanced Automation: To provide a backend infrastructure that supports workflow automation builders and users, enhancing their capabilities to design, execute, and manage workflows more effectively.

No UI Complexity: By focusing solely on the backend, the present invention eliminates the need for companies and third parties to develop and maintain a user interface for integration purposes, allowing them to focus on their core product offerings.

Scalability and Flexibility: To offer a scalable and flexible solution that can adapt to the evolving needs of businesses as they grow and as technology advances.

Overall, (PaaS) Parject as a Service is designed to improve the efficiency and effectiveness of business operations by providing a powerful, easy-to-use backend platform that supports a broad spectrum of integration and automation needs.

The present invention includes a system and process for integration of APIs in a no code environment. The present invention includes sending a customer request by an external source to a unique request gateway and processing the customer request by the unique request gateway. The present invention then communicates by the unique request gateway with a Parject as a Service connector, where the Parject as a Service connector has a Parject as a Service authenticator module for handling authentication and token injection. Then, the present invention communicates by the Parject as a Service connector with a schedule manager to handle polling. The present invention then returns, by the schedule manager, work with regular interval to the Parject as a Service connector and communicates by the Parject as a Service connector, with a dispatcher for handling APIs and callbacks. The present invention returns, by the dispatcher a dispatcher response to the Parject as a Service connector. A response from the Parject as a Service connector is sent back to the external source.

In an embodiment, the present invention includes a process for integration of APIs in a no code environment which further includes the unique request gateway communicating with the Parject as a Service connector, where the Parject as a service connector having bearer, API key, basic, and authentication functions. The Parject as a Service connector provides the token injection with the token injection communicating with a parameters field, and the parameters field communicating with body model, query parameters list, and path variables fields. Each of these, (the body model, the query parameters list, and the path variables field) communicate with a PCL request structure. Then in the process, the present invention determines the PCL request structure to send a provider request. The provider request is received from the dispatcher and communicates a provider response. The present invention determines the provider response as an error response or as a success response and communicates the provider response to a client.

### BRIEF DESCRIPTION OF THE DRAWINGS

FIG. 1 illustrates the entities in the present invention Parjects based application development system.

FIG. 2 illustrates the application development lifecycle using Parjects.

FIG. 3 is overall schematic of abstraction-based development system provided by Parjects.

FIG. 4 is a schematic of an application instance scenario with different Parject each is supported via different API providers.

FIG. 5 is a schematic illustration of the connections of a computing system.

FIG. 6 is a schematic illustration of the system of the present invention.

FIG. 7 is an illustration of the action flow of APIs for the present invention.

FIG. 8 is an illustration of the trigger flow for callback in the present invention.

FIG. 9 is an illustration of the portal display in the present invention.

FIG. 10 is a schematic of Parject as a Service enabling Parject and Interaction.

FIG. 11 is a schematic of a model to create a Parject.

FIG. 12 is a schematic of an interface of the present invention.

FIG. 13 is a schematic of the Dispatcher interface of the present invention.

FIG. 14 illustrates the general system architecture of the present invention.

FIG. 15 illustrate the system architecture with the present invention.

FIG. 16 is a flowchart of an embodiment of the present invention.

FIG. 17 is a flowchart of an embodiment of the present invention.

FIG. 18 is a flowchart of an embodiment of the present invention.

### DETAILED DESCRIPTION

The present invention is based on a computing abstraction layer which is formed of Parjects for any set of capabilities in the world. Parject based application development system has a set of entities that makes the platform available for end users and application developers.

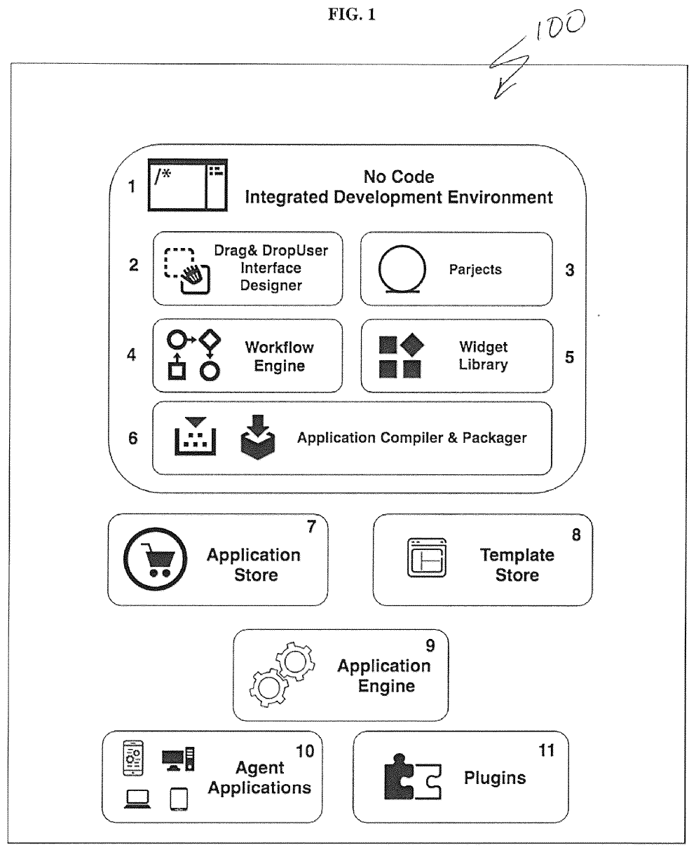

FIG. 1 shows entities of an object based application development system. A definition of each of the entities in FIG. 1 is provided below, with numbers referencing corresponding items and features in the accompanying drawing.

No Code Integrated Development Environment (IDE) (1): The no code integrated development environment is a main tool to give application developers ability to create applications over Parject based computing abstraction layer. IDE manages application and template development. Application project creation and development via drag and drop user interface designer, Parjects and workflow engine are the main practices of application development over IDE. Application compilers and packagers for web, mobile and desktop applications are provided via IDE.

Drag and Drop User Interface (UI) Designer (2): Application user interfaces for any type of application are created over IDE using a UI Designer which provides capabilities for creating different pages for different use cases. UI Designer module works with drag & drop capability using widget library. Each widget can be added via drag & drop interaction and page design can be done with mouse and keyboard controls. Those controls include positioning, sizing, styling, cut, copy, paste, group and other configurations which can be done over widgets. IDE activities are completely done without coding and targets also non-coder developers as well as experienced ones.

Parjects (3): Parjects are the main components of the present invention and are the software part or portion as an object. Parjects represent a variety of capabilities of worldwide APIs and plugins which work on desktop and mobile devices. Parjects are used over IDE as they are added to application projects and used as capability set in the applications. Parjects are formed of a set of attributes, interactions and callback events. Attributes represents the data model and relationships with other Parjects. Interactions represents the interactions that an end user(s) can do over a data content. Callback events are the system interactions that triggers from system state changes. Parjects are software parts as objects, and they provide a large set of capabilities to create any type application. Parjects are created via conversion of APIs and each Parject can have more than one API provider. The computing abstraction layer creates a complete abstraction via Parjects over APIs. An application is developed using Parjects 3 and packaged once. Then each application buyer has freedom to configure their application instance with different provider per Parject or Parject group than other buyers.

Workflow Engine (4): Parject based application development system enables development of applications using UI elements and Parjects 3. The application and business logic of application and connection between them is provided via workflow engine. Workflow engine 4 has a set of activities for: using Parject 3 interactions via gathering inputs from UI widgets or other data sources like old Parject interaction results or variables; displaying Parject interaction results and their data on UI widgets or saving them for future usages; UI manipulation capabilities like page direction, changing UI behaviors on runtime; callback, widget and error event trigger handling. The workflow engine 4 provides application developers chance of easily changing the application behavior and ability to create any type of application for any type use cases.

Widget Library (5): Parject based application development system enables development of applications using UI widgets, Parjects 3 and workflow engine 4. UI Design of web, mobile and desktop applications are managed completely using widget library 5. Each widget is added to designer via drag & drop action and configured over designer. Each widget has a set of properties to be configured at application development time, widget events to reflect end user activities to workflow engine and a set of functions to give ability to change its property configurations at application run time. Widgets are customized to Parject 3 and other widget interactions to make the development environment without coding and minimum user interaction for any type application developers.

Application Compiler & Packager (6): The applications developed over IDE are compiled and converted to an application bundle depending on selected platform. It can be a web application, a desktop application or it can be a mobile application or all of them. The applications are compiled into related platform's application and packaged from IDE.

Application Store (7): The packaged applications developed over IDE are versioned and deployed to application store 7 if application developer wants to sell it. The application store 7 is the main container for applications which are developed for sale. Application buyer can buy applications and configure them according different licensing options, and Parject providers.

Template Store (8): The applications developed over IDE can be packaged as application template for other developers to use it as a base and edit it. Application templates are published on template store 8 for sale. Application developers who do not want to start from scratch will have ability to purchase a template and start development on it. Templates are just the packaged versions of application projects.

Application Engine (9): The provisioned applications run on the application engine 9. For each application, a containerized instance is prepared, and the application is run over it. All the resource management, scalability and maintenance of application is managed by application engine.

Agent Applications (10): Parjects 3 represent capabilities of worldwide APIs as well as any computational IP connected device capabilities. For each platform there is an agent application that provides exposition of device capabilities as Parjects 3. Agent applications are responsible for plugin management and communication with devices.

Plugins (11): Each capability that works on IP connected devices is represented as plugin and run by the agent application 10. Any new plugin 11 can be added to system or removed without changing agent application 10.

### Application & Template Development

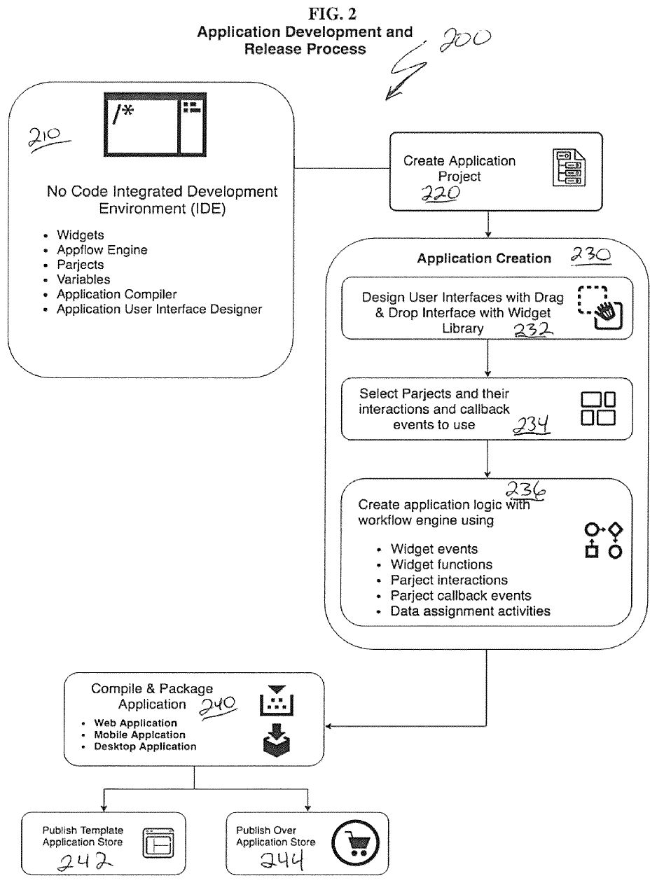

The application and template development is now described with reference to FIG. 2 for how the application development process 200 using Parjects 3 is managed. Parject based computing abstraction layer exposes as outputs like applications or templates. The application or template development process is very similar and the following activities are done during that process. Within the No Code Integrated Development environment 210, there exists the widgets, appflow engine, Parjects 3, variables, application compiler 6, and application user interface designer. The application project is created 220 according to purpose of application via platform selection web, mobile or desktop. Then, the Application development process includes a set of activities which depends on application, as shown with application creation step 230. Within the Application creation 230, there is design of user interfaces with a drag & drop designer and widget library 232, then adding Parjects 3 into project, by selecting Parjects 3 and their interactions and call back events to use 234; and then creating application logic with a workflow engine 236 combining one or more or all of: widget capabilities, such as widget events and widget functions with Parject interactions and callback events, and data assignment activities. After application creation is completed, the application development and release process 200 then performs compiling and packaging the application according to platform selection 240, including web application, mobile application, and desktop application. Depending on output, the process 200 includes publishing it as template for targeting application developers 242 or publish it as an application for targeting any type application buyers 244.

Application Run Time Lifecycle over Parjects

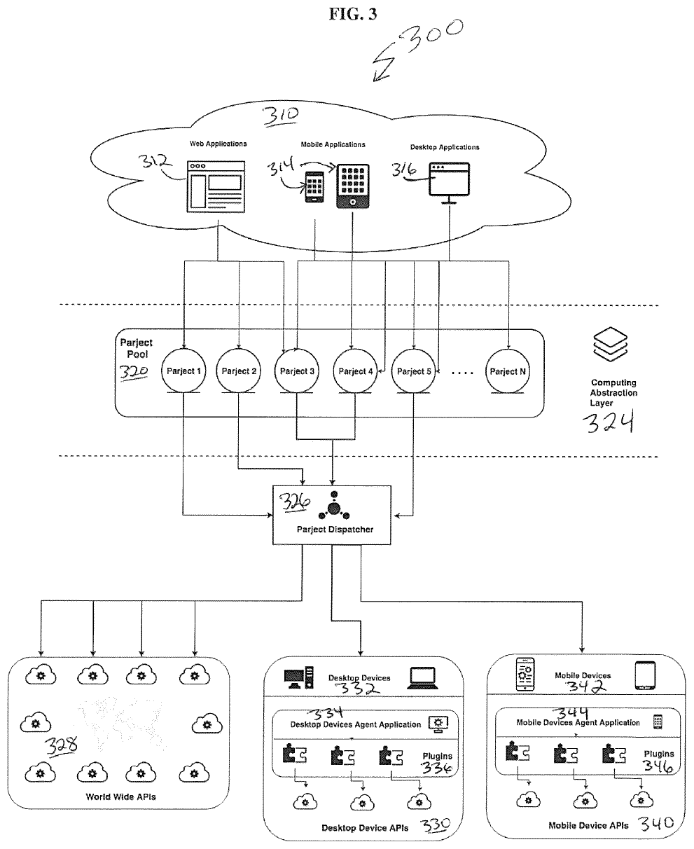

Referring to FIG. 3 for a description of how the Parject based computing abstraction layer 324 works during an application's lifecycle 300. The applications of type web application (312), mobile application (314) or desktop application (316) are created over IDE then packaged and published to application store. Each packaged application is provisioned with a specific configuration according to selection of application buyer. Each provisioned application runs on a cloud platform 310 which is based on Parject 3 based computing abstraction layer, 324, that is formed by a pool 320 of Parjects indicated by Parject-1 through Parject-N. Application interactions depending on the application logic is managed by application workflow engine. Application interactions are including Parject interactions as steps in the workflow engine 4. The flow of a Parject interaction can be illustrated as: Application logic requires an interaction which creates a Parject interaction usage. This Parject interaction goes over computing abstract layer 324 and sends a request to Parject Dispatcher module 326. The Parject Dispatcher module 326 checks the application provisioning information and finds the provider of related Parject. The Parject Dispatcher module 326 receives the provider mapping request of related Parject interaction. Depending on the type of request, it is sent to provider API (328,330,340). It can be either one that goes over a device-based API (330,340) or cloud API (328). Device based APIs are used for managing physical mobile (342) or desktop (332) devices. The device management capabilities are exposed via desktop agent applications (334) and mobile agent applications (344). Those agent applications (334,344) provide communication between Parject dispatcher (326) but their capabilities are exposed via desktop agent plugins (336) for desktop devices (332) and mobile agent plugins (346) for mobile devices (342). The result of Parject interaction is returns from the same path and come to Parject Dispatcher module (326) with a response mapping. The response is transmitted to application and application workflow logic continues to run.

Applications' Lifecycle with Different Parject Providers

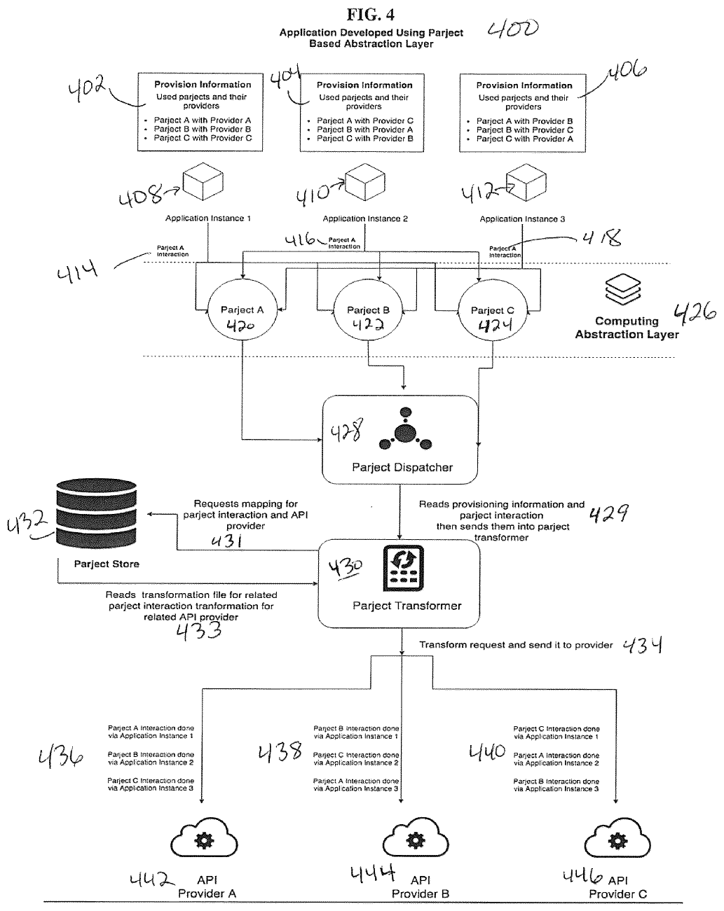

The applications' lifecycle with different Parject providers will now be described with reference to FIG. 4. As described in FIG. 4, there is shown how an application instance can work with different Parject providers. Applications developed over Parject based computing abstraction layer provides an abstract environment which enables same application to work with different API providers without editing anything in the application itself. An application 400 is created once but each instance is provisioned separately and has ability to be configured different. This capability forms the core part of this invention. Each application is only aware of Parjects which are the doors of an application to world APIs. A Parject can have more than one API provider with same capabilities and each provisioned instance of an application can use different providers for same application. However, each application instance behaves same and does same thing. This is achieved with Parject based computing abstraction layer (426) modules.

Referring again to FIG. 4, the following three flow paths simulates an application with three different application instances with three different Parject usages with three different provider provisioning. For the first path, Flow Path 1, the precondition is set as follows: Application Instance 1 (408) uses three Parject interactions which are interactions of Parject A (420), Parject B (422) and Parject C (424). Application Instance 1 (408) is provisioned with Provision Information 1 (402). The Parject interaction of A, Parject Interaction of B and Parject interaction of C is called from application instance. The Parject interactions are reflected to Parject Dispatcher (428) over Parject based computing abstraction layer (426) with Provisioning Information 1 (402). The Parject Dispatcher module 428 reads the Provisioning Information 1 (402) to get the provider information for used Parject. The Parject Dispatcher 428 passes Provisioning Information 1 (402) to Parject Transformer (430) module. Step (429). The Parject Transformer (430) module sends provider information and used Parject interactions to Parject Store (432) to get the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and send them to providers. Step (434). The request for interaction of Parject A is sent and communicated to API Provider A (442). Step (436). The request for interaction of Parject B is send and communicated to API Provider B (444). Step (438). The request for interaction of Parject C is send to API Provider C (446). Step (440). The responses from each of API Providers (442, 444, 446) follows the same path from opposite direction and finalizes as the Application Instance 1 (408) interaction result.

For the second path, Flow Path 2, the precondition is set as follows: Application Instance 2 (410) uses three Parject interactions which are interactions of Parject A (420), Parject B (422) and Parject C (424). Application Instance 1 (410) is provisioned with Provision Information 1 (404). The Parject interaction of A, Parject Interaction of B and Parject interaction of C is called from application instance. The Parject interactions are reflected to Parject Dispatcher (428) over Parject based computing abstraction layer (426) with Provisioning Information 2 (404). The Parject Dispatcher module 428 reads the Provisioning Information 2 (404) to obtain the provider information for used Parject. The Parject Dispatcher passes Provisioning Information 2 (404) to Parject Transformer (430) module. Step (429). The Parject Transformer (430) module sends provider information and used Parject interactions to Parject Store (432) to obtain the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and sends them to providers. Step (434). The request for interaction of Parject A is send to API Provider C (446). Step (440). The request for interaction of Parject B is sent to API Provider A (442). Step (436). The request for interaction of Parject C is send to API Provider B (444). Step (438). The responses from API Providers (442,444,446) follows the same path from opposite direction and finalizes as the Application Instance 2 (410) interaction result.

For the third path in FIG. 4, Flow path 3, the precondition is set as follows: Application Instance 3 (412) uses 3 Parject interactions which are interactions of Parject A (420), Parject B (422) and Parject C (424). Application Instance 1 (412) is provisioned with Provision Information 1 (406). The Parject interaction of A, Parject Interaction of B and Parject interaction of C is called from application instance. The Parject interactions are reflected to Parject Dispatcher (428) over Parject based computing abstraction layer (426) with Provisioning Information 3 (406). The Parject Dispatcher module reads the Provisioning Information 3 (406) to obtain the provider information for used Parject. The Parject Dispatcher passes Provisioning Information 3 (406) to Parject Transformer (430) module. Step (429). The Parject Transformer (430) module sends provider information and used Parject interactions to Parject Store (432) to get the mapped provider requests of Parject interactions. Step (431). The Parject Transformer (430) reads the transformation files for related Parject interaction transformations for related API provider from Parject Store (432). Step (433). The Parject Transformer (430) transforms the requests for related providers and send them to providers. Step (434). The request for interaction of Parject A is sent and communicated to API Provider B (444). Step (438). The request for interaction of Parject B is send and communicated to API Provider C (446). Step (440). The request for interaction of Parject Cis sent and communicated to API Provider A (442). Step (436). The responses from each of API Providers (442,444,446) follows the same path from opposite direction and finalizes as the Application Instance 3 (412) interaction result.

The present invention has numerous advantages as it provides a new computing abstraction layer for all over the world's computational capabilities. This invention provides for API providers to reach many audiences with increasing their value with combination with other APIs that they are not able realize. It removes walls between products as representing them as Parjects. Further, the present invention provides the advantage of a no code application development environment over computational abstraction layer of Parjects in which updating, orchestrating, and testing applications is very easy and does not require deep technical knowledge. Moreover, deploying and running applications requires no effort. The customization of applications are very effortless using applications templates.

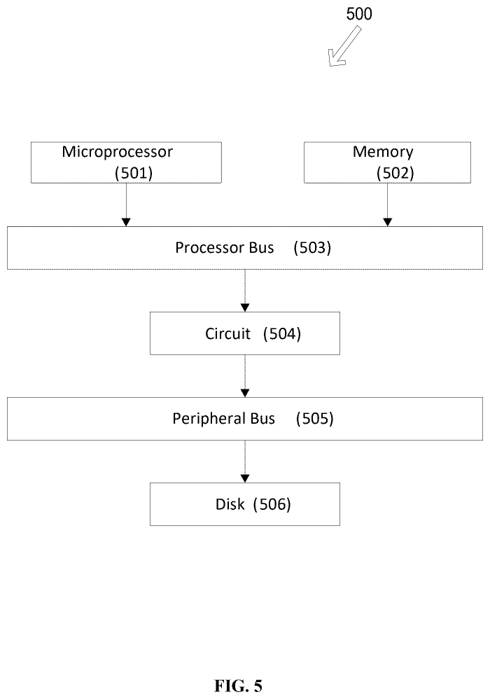

The present invention is used with the following FIG. 5 of computer systems, components, and internet access. FIG. 5 illustrates a system of a computer or device which includes a microprocessor 501 and a memory 502 which are coupled to a processor bus 503 which is coupled to a peripheral bus 505 by circuitry 504. The bus 505 is communicatively coupled to a disk 506. It should be understood that any number of additional peripheral devices are communicatively coupled to the peripheral bus 505 in embodiments of the invention. Further, the processor bus 503, the circuitry 504 and the peripheral bus 505 compose a bus system for computing system 500 in various embodiments of the invention. The microprocessor 501 starts disk access commands to access the disk 506. Commands are passed through the processor bus 503 via the circuitry 504 to the peripheral bus 505 which initiates the disk access commands to the disk 506. In various embodiments of the invention, the present system intercepts the disk access commands which are to be passed to the hard disk.

The present invention is PaaS-Parject as a Service is a comprehensive backend package designed to simplify and enhance the integration and automation of API interactions for businesses globally. This service does not include a user interface but provides an extensive backend similar to the backend structure of workflow automation builders and automation platforms. PaaS is a backend platform designed to streamline and optimize API interactions for companies, particularly those involved in workflow automation and integration of various online services. The core components of this invention are structured to handle various functionalities that streamline API management, authentication, exclusive service offers, helpers, descriptors and interaction through a unified system. The package is structured around a microservice architecture, central to which are the Dispatcher and PAASAuthentication microservices.

The present invention, PaaS-Parject as a Service, is a sophisticated backend package designed to streamline and simplify the integration and management of API interactions across a diverse range of service providers, referred to as “parjects” within the system. This system provides a complete solution for businesses, particularly those involved in workflow automation and flow builders, allowing them to connect globally with all providers through a unique, standardized request mechanism.

The construction and design of the system of the present invention includes the following elements. First is the “Microservices Architecture,” which is the backbone of the Parject as a Service (PaaS) and comprises key components like the Dispatcher and PAASAuthentication. These services manage the routing and authentication of API requests, ensuring secure and efficient interactions.

The microservice “Dispatcher” acts as a protocol connector layer, akin to Postman's backend. It captures all API responses and errors, making them accessible to users. The Dispatcher ensures that API responses are handled efficiently and consistently. This is crucial for businesses that need real-time response handling and error management.

The PAASAuthentication microservice manages all aspects of user authentication across various API interactions. It supports multiple authentication types, including OAuth, ApiKey, and Basic, providing secure access to third-party services. PAASAuthentication processes authentication requests, stores and retrieves tokens, and ensures that each API interaction is authenticated before proceeding. It handles various authentication types (OAuth, ApiKey, Basic), managing and injecting authentication details into each API request. This microservice simplifies the authentication process across different providers, ensuring secure access to required APIS.

### Operation:

The operation of PaaS-Parject as a Service involves several key processes. These include access to all Parjects, Unique Request Gateway, API Interaction, Cashing Strategy, and JSON-based Configuration. Each are described below.

First, Access to all Parjects: This API retrieves all project and interaction details, crucial for UI rendering in systems that choose to build a front-end interface. The API utilizes a caching strategy to optimize performance and ensure data freshness, fetching and storing data daily, with a weekly refresh.

The Unique Request Gateway acts as a single entry point for all API requests, conforming to a standardized model that simplifies the integration process. This gateway ensures that all requests are uniformly structured and handled, promoting consistency across interactions.

The API Interaction: Users interact with APIs through a standardized gateway, known as the Unique Request Gateway, which simplifies the submission of requests across various Parjects (providers). This gateway standardizes how requests are made, ensuring consistency and reliability.

Caching Strategy: To optimize performance, the system implements a caching strategy where data, such as API responses, are stored temporarily to reduce the number of requests made to an API. This not only improves response times but also decreases the load on the network.

JSON-based Configuration: Companies can use parject JSONs to configure and customize their interactions, allowing for a high degree of flexibility in how they integrate and use external services.

### Preparation:

Companies can utilize the parject JSONs provided by the system to design and construct custom user interfaces, enabling a high degree of customization and flexibility in how they interact with various APIs.

The PaaS package allows for the expansion of backend functionalities as businesses can add new parjects and interactions through the ecosystem interface provided by the service.

The present invention provides numerous improvements over traditional methods of API integration and management. Among these are:

Global Connectivity: Unlike traditional methods that require manual integration for each provider, PaaS-Parject as a Service enables seamless connectivity to a global network of providers through a standardized request, significantly reducing integration complexity and time.

Unified Integration Platform: Provides a unified approach to managing API interactions, which is a substantial improvement over managing multiple middleware solutions or custom connector services.

Enhanced Automation: Supports the creation of custom Action/Trigger structures, offering significant advantages for workflow automation by allowing companies to tailor their workflows precisely.

Scalability and Flexibility: Designed to be highly scalable and adaptable, accommodating new providers or changes in existing APIs without the need for extensive redevelopment.

Security and Authentication: Streamlines the authentication process across different APIs, enhancing security while reducing the complexity and potential errors associated with custom authentication systems.

The advancements and functionalities detailed herein represent significant improvements over older methods, providing a more efficient, secure, and user-friendly way to manage API integrations and data interactions. The changes and improvements over previous methods demonstrate significant advancements in terms of efficiency, security, and flexibility, making PaaS-Parject as a Service a pioneering solution in the field of API management and integration.

PaaS-Parject as a Service presents several significant advantages over traditional approaches to API integration and management, leveraging sophisticated technical features to deliver a superior solution:

Comprehensive Backend Package: Unlike conventional platforms that might offer either integration or authentication services, PaaS-Parject as a Service provides a full backend package without a UI. This enables users to focus on backend integration without being constrained by front end complexities.

Streamlined Integration Process: The invention uses a unified request gateway and a comprehensive set of microservices, including Dispatcher and PAASAuthentication, to manage all API interactions. This streamlined approach reduces the complexity traditionally associated with integrating multiple APIs from different providers.

Unified Integration Approach: The system uses a unique protocol connector layer called the Dispatcher, which standardizes the handling of all API responses and errors. This standardization simplifies the integration process, making it more efficient than dealing with multiple, disparate API standards.

Advanced Authentication Management: Through the PAASAuthentication microservice, the platform handles various authentication types (OAuth, ApiKey, Basic), automatically injecting these into the API requests. This not only streamlines the authentication process but also enhances security across all provider interactions.

Customizable Workflow Automation: By utilizing parject JSONs, companies can create custom Action/Trigger structures, tailoring their workflow automation precisely to their needs. This is especially valuable for businesses that require specific, customized workflows that traditional platforms cannot provide.

Global Provider Connectivity: The getAllParjects API fetches all necessary project and interaction details for UI rendering, supporting a caching strategy to maintain data freshness. This feature allows businesses to connect with any global provider through a single, standardized request, dramatically expanding their operational scope and reducing integration times.

Scalability and Flexibility: The ability to add new Parjects and interactions through an ecosystem interface means businesses can dynamically expand their backend functionalities as needed. This adaptability is crucial for companies that need to respond quickly to new market opportunities or technological advancements.

Efficient Data Management: The implementation of a smart caching strategy in the getAllParjects API minimizes the overhead of repeated data requests, ensuring that data remains current without the constant need for refreshes. This approach significantly enhances the performance and reliability of the system.

Simplified API Gateway: The Unique Request Gateway standardizes the submission of all API requests, ensuring that they conform to a single model. This reduces complexity and eliminates the potential for errors associated with handling multiple integration protocols.

Enhanced Security and Error Handling: With advanced error handling capabilities and secure authentication management, the system ensures that all interactions are not only secure but also reliably managed to prevent data breaches and unauthorized access.

Operational Efficiency: By automating and simplifying many of the tasks traditionally associated with API integration and management, PaaS-Parject as a Service allows businesses to allocate resources more efficiently, focusing on core operations and strategic initiatives rather than backend maintenance.

These advantages make PaaS-Parject as a Service a powerful tool for businesses looking to optimize their backend integrations, reduce operational complexities, and maintain a competitive edge in the rapidly evolving digital landscape.

In the development and application of PaaS-Parject as a Service, unexpected results and features have emerged that are particularly surprising given the traditional landscape of API management and integration systems, including but not limited to the following:

Handling Surges in Customer and Parject Load: One unexpected outcome is the system's ability to handle surges in the number of customers and parjects without significant degradation in performance. As the customer base and the number of integrated parjects grow, traditional systems often struggle with scalability and can become overwhelmed by the increased load. The PaaS-Parject system's architecture, designed for scalability, maintains high performance even under these rare but critical conditions.

Adaptation to Emerging Authentication Types: The emergence of new authentication types and requirements presents a rare challenge that leads to unexpected developmental needs for the PaaS-Parject system. Integrating new authentication methods as they become prevalent in the industry is not typically planned in the initial design of such systems. However, the ability of PaaS-Parject to adapt and incorporate these new methods swiftly is a beneficial outcome, ensuring it remains compatible and secure as authentication technologies evolve.

Custom Requirements During UI Integration by Workflow Platforms: Workflow automation builders or flowbuilder platforms integrating the PaaS package might encounter unexpected needs specific to their user interfaces. The development of additional functionalities or customizations in the PaaS package that were not initially anticipated is a significant benefit of the system of the present invention. Such adaptability to user-specific requirements, although rare, enhances the package's applicability and usability, providing tailored solutions that were not initially foreseen.

Unexpected Efficiency in Handling API Overloads: The system's intelligent load balancing and request handling mitigates API rate limit issues that are common with third-party services. By efficiently caching and managing request frequencies, PaaS-Parject as a Service can maintain service continuity even under high demand, which is a rare feature in conventional systems where rate limit errors usually require manual intervention or complex additional solutions.

Seamless Integration with Legacy Systems: One of the more surprising outcomes is the ease with which this system integrates with legacy platforms. Despite the advanced nature of the PaaS-Parject as a Service, its adaptable design allows it to interface surprisingly well with older technologies, facilitating a smoother transition for companies with established IT infrastructures, which is often a challenge with newer technologies.

These features highlight the dynamic nature of PaaS-Parject as a Service, demonstrating its potential to adapt and evolve in response to rare and unforeseen demands. This adaptability not only ensures the system's resilience and relevance but also enhances its value to users by addressing their unique and evolving needs.

PaaS-Parject as a Service, is a comprehensive backend package designed to facilitate and simplify the integration of various cloud services and APIs without the need for a frontend user interface. This platform is geared towards businesses and developers who require robust backend capabilities, particularly those involved in workflow automation and management.

### Uses of PaaS-Parject as a Service:

API Integration: The software allows seamless integration with multiple third-party APIs, supporting diverse authentication mechanisms and providing a unified method for handling API interactions. This capability is crucial for businesses that rely on numerous external services for data exchange and operations.

Workflow Automation: By leveraging the Dispatcher microservice within the platform, companies can automate and streamline complex workflows. This is particularly beneficial for industries where processes involve multiple steps and require various data inputs and outputs across different platforms.

Customization and Flexibility: Users can customize their integration and workflow solutions using the provided parject JSONs. This allows for tailored solutions that meet specific business needs, enhancing functionality and user experience.

Security and Compliance: The platform ensures that all data transactions are secure and compliant with industry standards, providing robust authentication management and secure data handling protocols.

Scalability: PaaS-Parject as a Service is designed to scale with the business, accommodating an increasing number of users and data loads without compromising performance.

Developer Tools: It offers various tools and resources for developers, making it easier to create, test, and deploy integrations and services quickly and efficiently.

This software is suitable for a wide range of industries including but not limited to finance, healthcare, retail, and technology sectors, where integration with multiple APIs and cloud services is a necessity for operational efficiency and innovation.

The present invention of PaaS-Parject as a Service primarily revolve around its backend-focused architecture, flexibility in integration, and advanced user authentication management, which collectively address several limitations present in existing software products on the market. The present invention PaaS-Parject as a Service is distinct from the prior software solutions as described below.

Backend-Only Focus with No UI Complexity: Unlike many integration platforms like Zapier and IFTTT, which provide both backend and user interface solutions, PaaS-Parject as a Service exclusively focuses on backend functionalities. This specialization allows it to provide more robust and sophisticated backend services without the overhead of maintaining a frontend, thereby enhancing performance and reducing complexity for users who only need backend capabilities.

Unified Standard for API Interactions: The software uses a unique approach by treating all provider interactions through a single, unified protocol, facilitated by the Dispatcher microservice. This is in contrast to typical platforms that may require separate integrations for each API. This unified approach simplifies the integration process significantly and reduces the integration time and cost for businesses.

Advanced Authentication Management: Through its PaaSAuthentication microservice, the present invention manages complex authentication schemes across various APIs automatically. This feature is particularly novel as it handles a range of authentication types (OAuth, ApiKey, Basic) seamlessly, which is a significant improvement over platforms where users must manually manage or code authentication protocols.

Scalable and Customizable Integration Options: The platform allows users to dynamically add new “parjects” (providers) and define their interactions through an easy-to-use ecosystem interface. This level of customization and scalability is particularly valuable for businesses that need to rapidly adapt to new technologies or scale their operations without reengineering their entire systems.

Enhanced Data Management with Caching Strategy: The inclusion of a smart caching strategy in the getAllParjects API is another aspect that optimizes performance and ensures data freshness without frequent requests, which is not commonly addressed in current platforms.

By focusing on these areas, PaaS-Parject as a Service provides a more efficient, secure, and user-oriented solution compared to existing products. It addresses common deficiencies such as the complexity of managing multiple API integrations, the overhead of handling authentication securely, and the challenges associated with scalability and customization in integration platforms. These innovations make it a valuable tool for businesses looking to enhance their backend systems and automate complex workflows efficiently.

### Architecture Overview:

PaaS-Parject as a Service is designed around a microservices architecture, emphasizing modularity and allowing independent scaling and development of different functionalities. The core components of this architecture include:

Dispatcher: Acts as the protocol connector layer, handling all API communications. It receives API calls, manages these interactions according to predefined protocols, and directs them to the appropriate parjects (providers). This component ensures that API responses are correctly managed and errors are efficiently handled.

PaaSAuthentication: This microservice manages all aspects of authentication across various APIs. It supports multiple authentication types, such as OAuth, ApiKey, and Basic, automatically injecting the necessary authentication tokens into API requests. This system enhances security by centralizing authentication management, thereby reducing the potential for security breaches.

Parject Management: Users can dynamically add new parjects and customize their interactions through an intuitive ecosystem interface. This flexibility allows businesses to expand their backend functionalities as needed without significant reconfigurations.

The present invention has numerous capabilities. These are described below.

API Integration: Seamlessly integrates with an extensive array of APIs, providing a standardized approach to manage diverse API interactions. This integration is facilitated through a unique request model called the Unique Request Gateway, which standardizes how requests are handled and processed.

Workflow Automation: Enables users to create sophisticated workflow automations utilizing parject JSONs, which define the structure and flow of data between various services. These workflows can be as simple or complex as required, supporting conditional logic, looping, and real-time data processing.

Customization and Scalability: The software's design allows for high levels of customization and scalability. Companies can tailor the functionality to their specific needs and scale up as their requirements grow, all without compromising on performance or security.

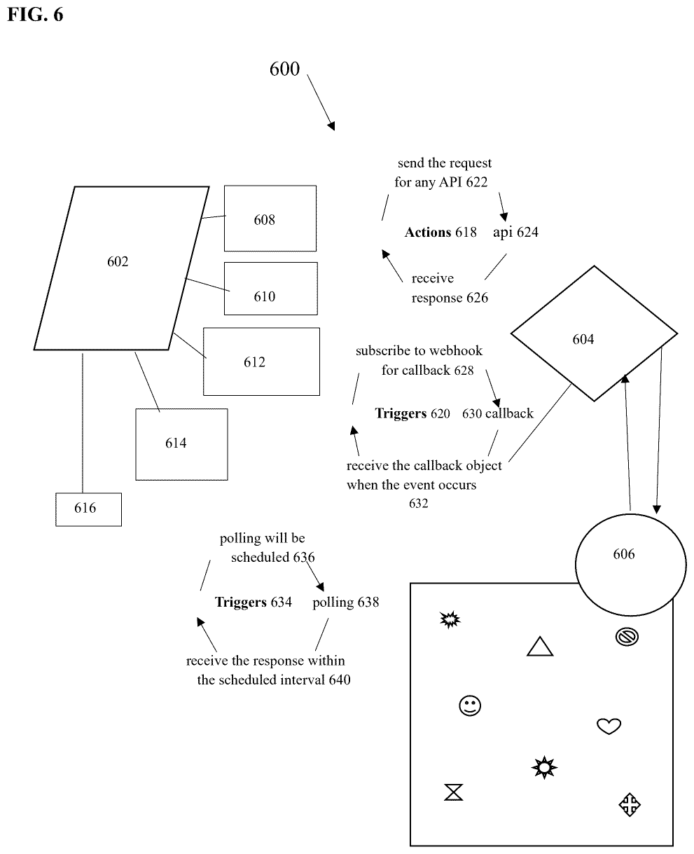

Referring to FIG. 6, there is shown the present invention of PaaS 600. The clients and platforms integrating with the PaaS package are shown 602, with the PaaS package 604 connected to third party providers 606. For the clients and platforms integrating with the PaaS package 602, there is included workflow authorization builders 608, users of flow builders 610, integration and automation platforms 612, process automation platforms 614, and other type of platforms or systems 616. Also shown are the actions 618 and triggers 620 between PaaS 604 and the client and platforms that are integrating with the PaaS package 602. Actions include sending the request 622 for any API 624 and receiving its response 626. With the triggers 620, there are subscribing to webhook for callback 628, communicating with callback 630, and then receiving the callback object when the event occurs 632. Another one of the shown triggers 634 is polling with the steps of polling being scheduled 636, then polling 638, and receiving the response within the scheduled interval 640. The PaaS 604 connects with the third party providers 606.

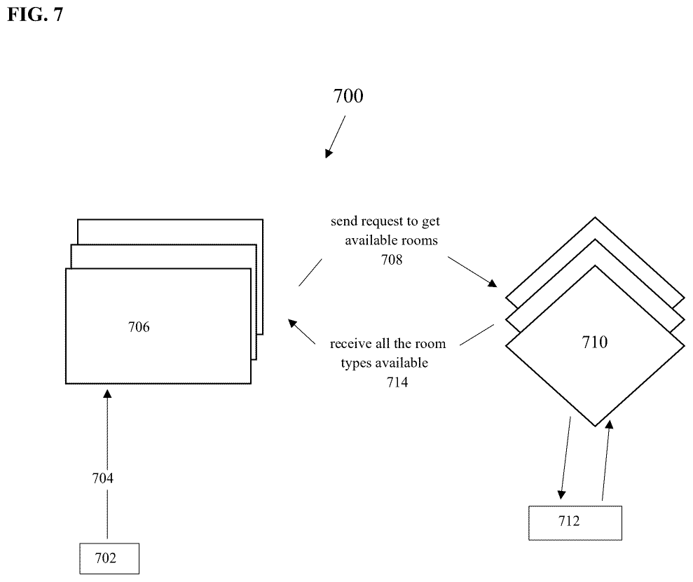

FIG. 7 illustrates the action flow for API(s) 700. In the diagram, the client 702 sends request for available rooms 704 for booking such as at hotels, which communicates with the workflow automation builders 706. This sends request 708 to PaaS 710 to obtain the available rooms. PaaS 710 which is in communication with the third party provider such as “Lodgify” 712. PaaS 710 receives all the room types available from third party provider, ie. “Lodgify”, 714 and then sends this back to the workflow automation builder 706.

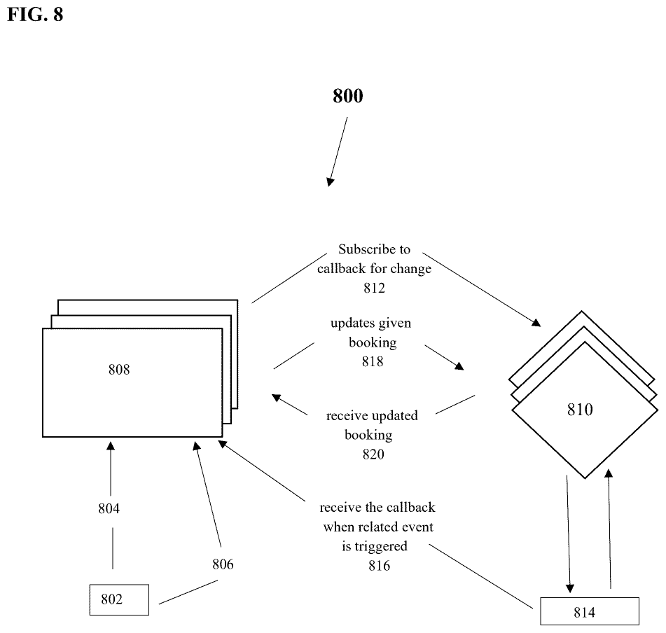

FIG. 8 illustrates the trigger flow for callback 800. The client 802 communicates a booking change 804 to the workflow automation builder 808. User subscribes to callback for a booking change 812 which is communicated to PaaS 810 and then communicated to Lodgify or other third party 814, with information sent back to PaaS 810 as well from the third party 814. Workflow automation builder 808 receives the callback from Lodgify 814 when related event is triggered 816. Similarly, the client wants to update the booking 806, the request is sent to the workflow automation builder 808, with the booking updates given to PaaS 818 for communication and feedback from Lodgify or other third party provider 814. The updated booking is received by the workflow automation builder from PaaS 820.

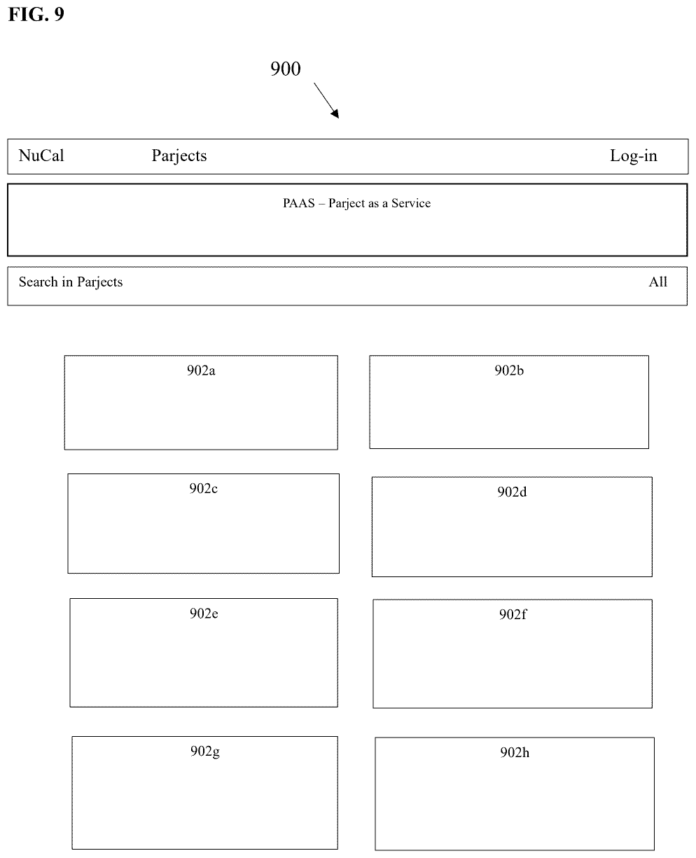

FIG. 9 illustrates the public portal 900 which displays all the parjects and interactions that are provided, along with their technical details broken down at the Action/Trigger level. Multiple parjects (902a-902h) are shown which can be selected by the user in the portal, and in use with the present invention.

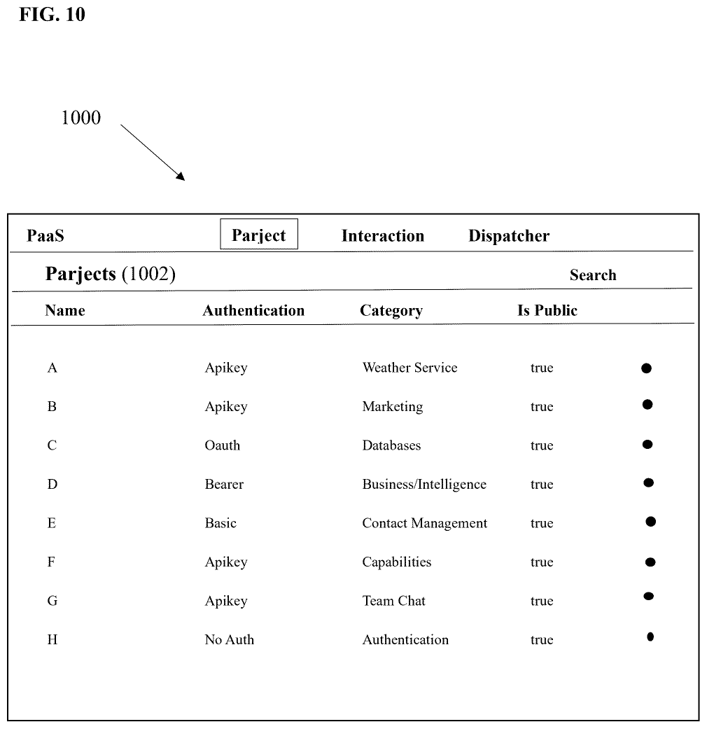

FIG. 10 illustrates the PaaS ecosystem 1000 which enables the creation of Parject and Interaction. Multiple parjects 1002 (A-H) are shown by name, authentication, category, and if it is public.

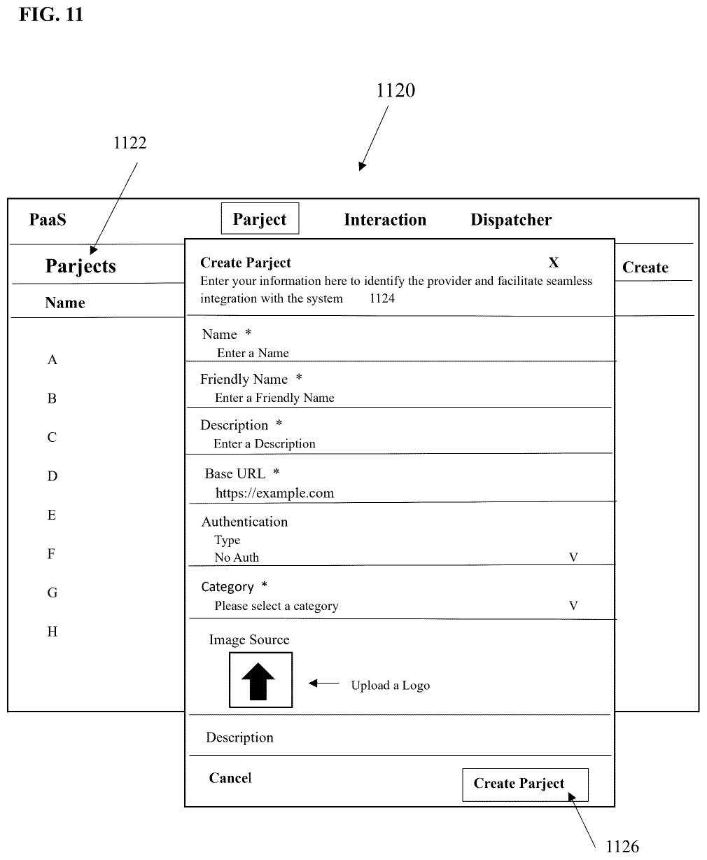

FIG. 11 is the model 1120 that is used to create a Parject. In creating a parject 1122, information is entered to identify the provider and facilitate seamless integration with the system. Information 1124 entered includes names, description, base url(s), authentication type, categories, image source(s)—which includes uploading a logo, and descriptor. After the information is entered, the “Create Parject” button in selected 1126.

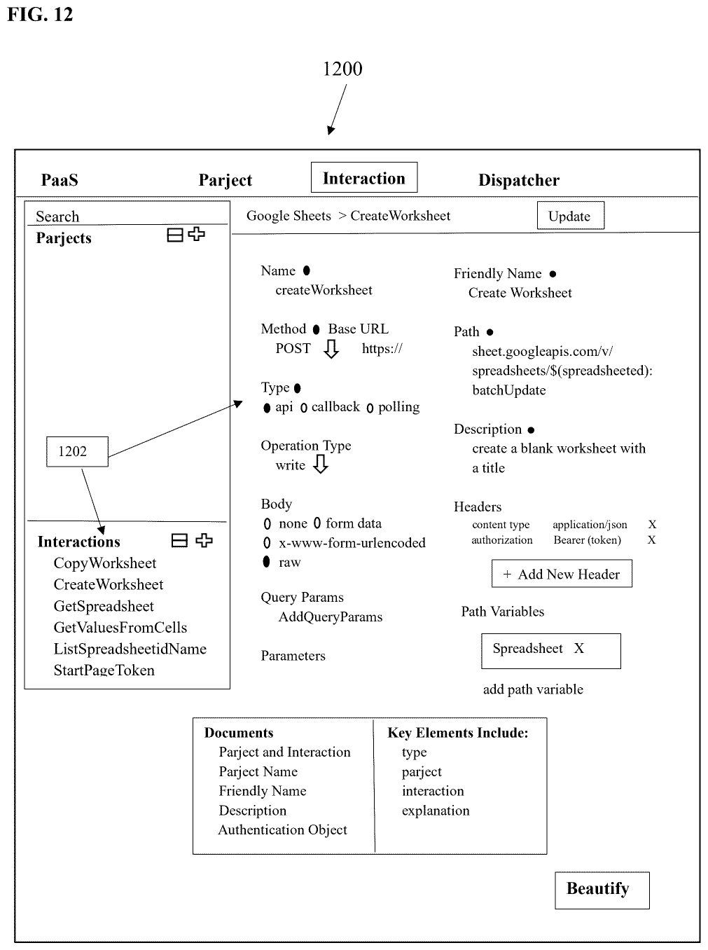

FIG. 12 is an illustration of an advanced interface 1200 that defines interactions as type/api/callback/polling 1202.

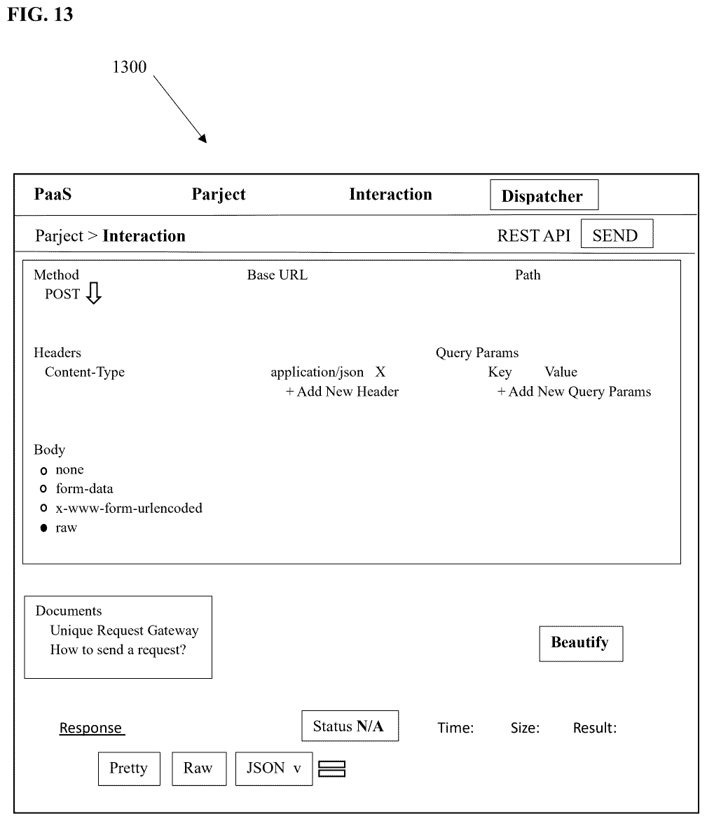

FIG. 13 is an illustration of the Dispatcher 1300 where unique request gateway interactions are conducted. Unique request gateway is a standardized model designed to streamline the submission of all parject requests. This model requires that every request follows a specific set of guidelines known as the gateway. It acts as a single entry point for all gateway requests.

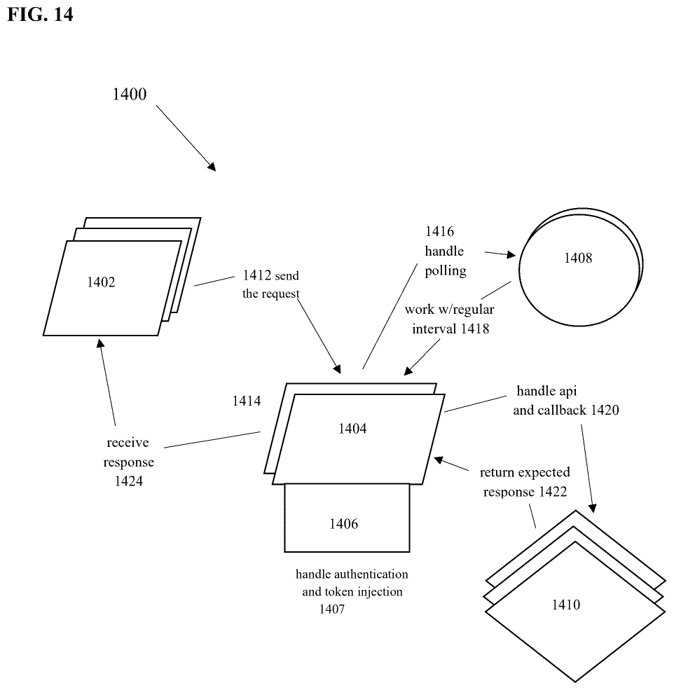

The general system architecture 1400 is outlined in FIG. 14. As shown, there includes the PaaS external customers 1402, the PaaS connector 1404 with PaaS authentication 1406, the Scheduler manager 1408, and the Dispatcher 1410. The PaaS external customers 1402 send the request 1412, which goes through the unique request gateway processing 1414 to the PaaS connector 1404. Within the PaaS connector 1404 is PaaS authenticator 1406 which handles authentication and token injection 1407. The PaaS connector 1404 handles polling 1416 and communicates to the schedule manager 1408, which in turn communicates back to the PaaS connector 1404 work and projects on a regular interval 1418. The PaaS connector 1404 also handles api and callback 1420 by communicating with Dispatcher 1410. The Dispatcher 1410 then returns an expected response 1422 to PaaS connector 1404. The PaaS connector 1404 then communicates a response back to the PaaS external customers 1402, which receive the response 1424.

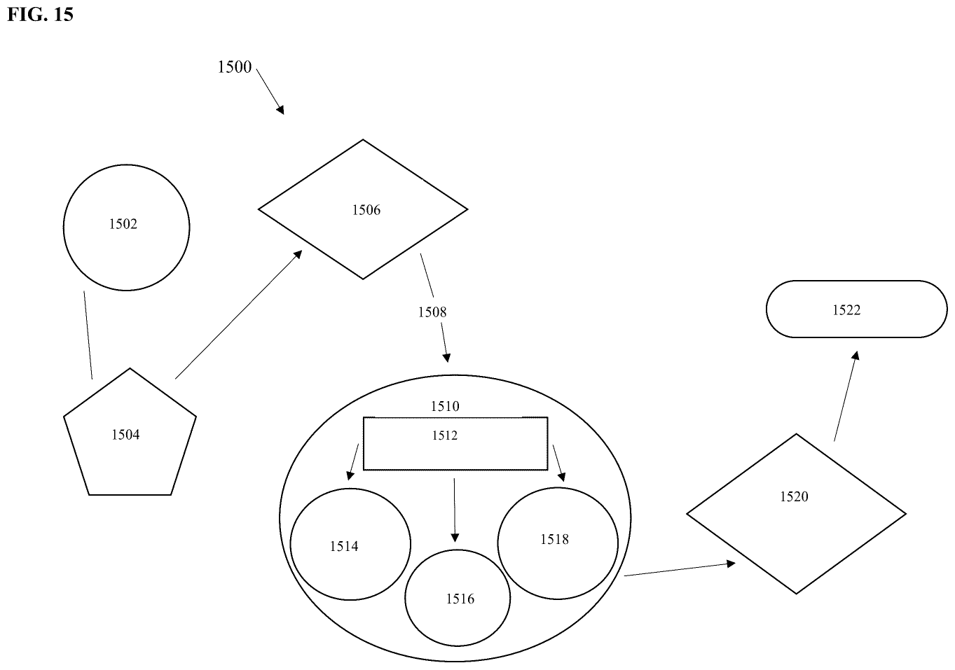

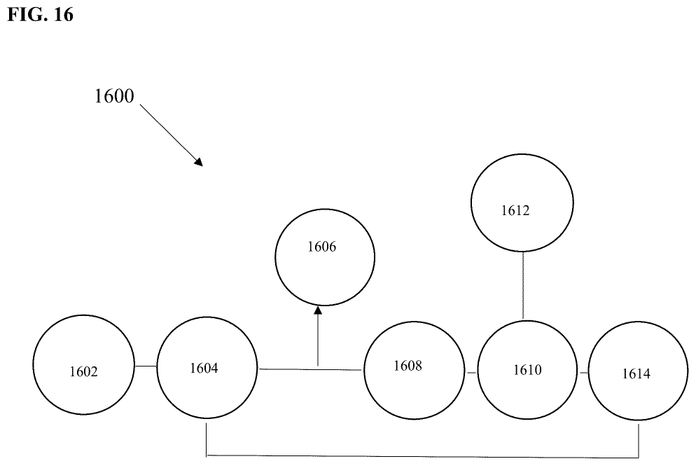

The system architecture in FIGS. 15 and 16 includes the creation of ‘parject’ and ‘interaction’, and the development of providers in the PaaS package. In FIG. 15, there is the resource connector interface 1502 communicating with the front end interface and app portal 1504. This communicates: the API, Action callback, instant polling, and scheduled events 1506 to PaaS system 1508. Within the PaaS system 1508, there is the core ecosystem 1510. The unique request sending infrastructure 1512 communicates with the PaaS authentication microservice 1514, the PaaS dynamic fields 1516, and the Dispatcher protocol connector microservice 1518. The core ecosystem 1510 enables the trigger/action to create structure 1520 which is communicated to PaaS customers 1522.

In the embodiment 1600 shown in FIG. 16, there is the user login app portal 1602 in communication with the app portal Parject interface 1604. This Parject interface 1604 stores tokens 1606 as it communicates with Parject settings 1608. The Parject settings 1608 communicate with Parject interaction settings 1610 which can perform the Parject test 1612. The Parject interaction settings 1610 then make the Parject accessible 1614. When the Parject is accessible 1614, the Parject is available for the app portal Parject interface 1604.

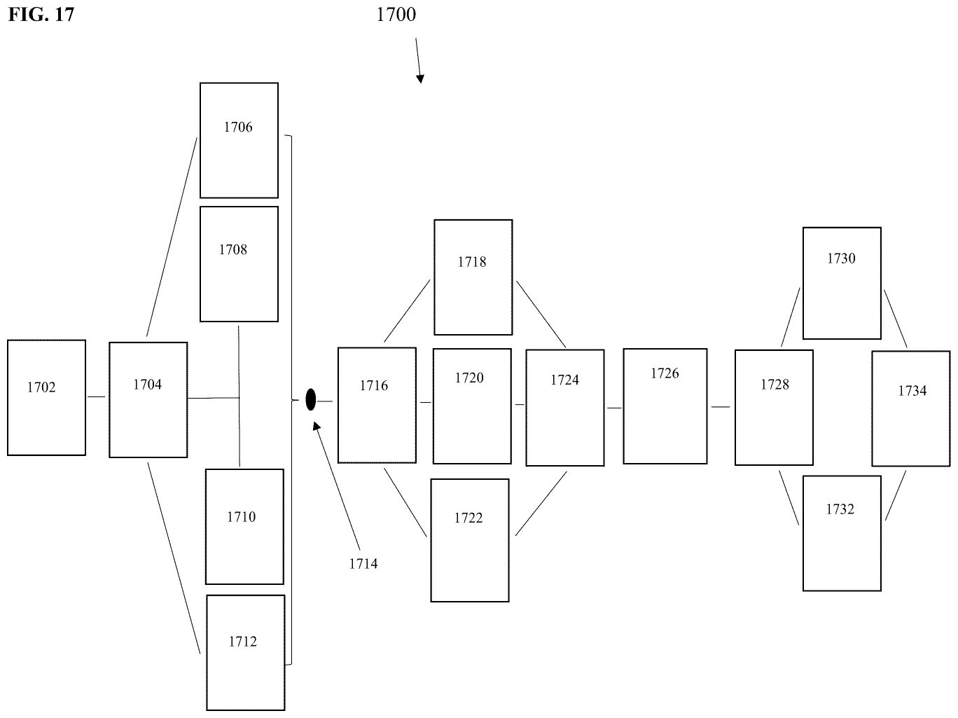

The stages that a request goes through in the ‘Unique Request Gateway’ are shown in the flowchart 1700 of FIG. 17. The unique request gateway 1702 communicates with the PaaS 1704. Within the PaaS 1704 is included the Bearer 1706, API Key 1708, Basic 1710, and OAuth 1712 functions. These four functions (1706, 1708, 1710, and 1712) are part of the token injection 1714. The token injection 1714 is in communication with the parameters field 1716. The parameters field 1716 is in communication with each of: body model 1718, query params list 1720, and path variables field 1722, which in turn are each in communication with the PCL request structure 1724. The PCL request structure 1724 communicates with the provider request from Dispatcher 1726 which communicates the provider response 1728. From the provider response 1728, there is the communication with the error response model 1730 and the success response model 1732, each of which are in communication with the client 1734.

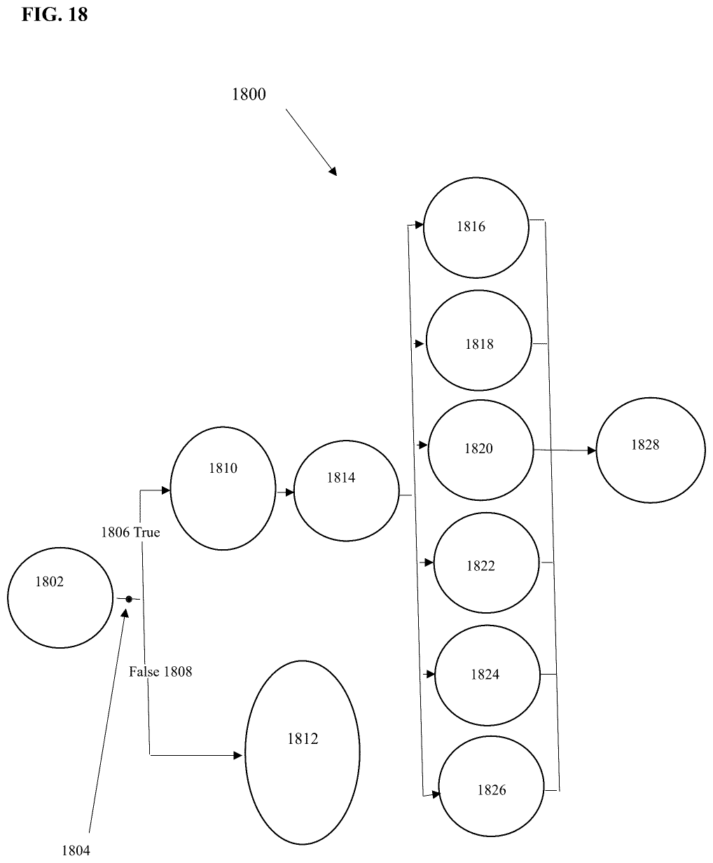

The flowchart of FIG. 18 shows the stages of the polling process and the decision mechanism 1800. For the process, when any request is to be sent 1802, first check the scheduler field 1804, which decides based on a true/false logic (or yes/no decision) 1806, 1808. If the decision tree indicates a false value 1808, then the process transforms and dispatches the request (via API callback) 1812. If the decision tree indicates true value 1806, then the process communicates to the task service or scheduler service at a polling step 1810. Next, the process checks the type of field 1814. The type of fields include, but are not limited to: enable/create 1816, disable/delete 1818, update 1820, start 1822, pause 1824, and stop 1826. After the type of field is selected, the process returns a custom response 1828.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium-which is defined below) that can contain, or store a program. The terms “machine readable medium,” “computer-readable medium,” or “computer readable storage medium” are all non-transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A process for integration of APIs in a no code environment comprising:
sending a customer request by an external source to a unique request gateway;
processing said customer request by said unique request gateway;
communicating, by said unique request gateway, with a Parject as a Service connector, said Parject as a Service connector having a Parject as a Service authenticator module for handling authentication and token injection;
communicating by said Parject as a Service connector with a schedule manager to handle polling;
returning by said schedule manager, work with regular interval to said Parject as a Service connector;
communicating, by said Parject as a Service connector, with a dispatcher for handling APIs and callbacks;
returning by said dispatcher a dispatcher response to said Parject as a Service connector;
sending a response from said Parject as a Service connector to said external source.

2. The process for integration of APIs in a no code environment according to claim 1 further comprising,
said unique request gateway communicating with said Parject as a Service connector, said Parject as a service connector having bearer, API key, basic, and authentication functions;
said Parject as a Service connector providing said token injection;
said token injection communicating with a parameters field, said parameters field communicating with body model, query parameters list, and path variables fields;
said body model, said query parameters list, and said path variables field communicating with a PCL request structure;
determining said PCL request structure to send a provider request;
receiving said provider request from dispatcher and communicating a provider response;
determining said provider response as an error response or success response;
communicating said provider response to a client.
